(19) United States
(12) Patent Application Publication
(10) Pub. No.: US 2012/0097027 A1
(43) Pub. Date: Apr. 26, 2012

(54) METHOD AND SYSTEM FOR PURIFYING BIOGAS FOR EXTRACTING METHANE

(75) Inventor: Lothar Gunther, Geretsried (DE)

(73) Assignee: DGE DR.-ING. GUNTHER ENGINEERING GMBH, WITTENBERG (DE)

(21) Appl. No.: 12/995,373

(22) PCT Filed: May 22, 2009
(86) PCT No.: PCT/EP09/03656

§ 371 Date: Mar. 3, 2011

(30) Foreign Application Priority Data
May 30, 2008 (DE) 10 2008 025 971.3

(51) Int. Cl. B01D 53/14; B01D 19/00; B01D 53/30

(52) U.S. Cl. 95/8; 95/166; 95/26; 96/202

(57) ABSTRACT

A method for extracting methane purifies a biogas and components present in the biogas, such as carbon dioxide, sulfur compounds, and ammoniac are separated in a plurality of different process steps. The method for extracting methane is characterized by low energy consumption and allows an increase in methane content of at least 10%. In a first purifying step, carbon dioxide, hydrogen sulfide, ammoniac, and other water-soluble organic substances present in the raw gas are removed in a washing column at a standard pressure or at overpressure of up to 6 bar by use of fresh water. The methane gas having a methane content of at least 65% is drawn off at the head of the washing column. Methane and carbon dioxide dissolved in the wash water are sequentially separated from the contaminated wash water discharged from the washing stage, in a first stripping column and subsequently in a second stripping column, by adding stripping air under standard pressure. An oxygenic stripping gas having fuel gas quality arises in the first stripping stage. The purified wash water accruing in the second stripping stage is returned to the washing stage.

The invention relates to a method of purifying biogas for extracting methane in which components contained in the biogas such as carbon dioxide, sulfur compounds and ammonia are separated in a plurality of different process steps, and to a suitable system for carrying out the method.

Biogas is formed by the anaerobic (oxygen-free) digestion of organic material and is used as a renewable energy source. The gases produced are classified as sewage gas, digester gas, landfill gas and biogas, depending on the respective raw materials used, such as sewage sludge, slurry, manure, waste material of vegetable or animal origin and biological raw materials.

All the above-mentioned gases will henceforth be referred to as biogas.

The main components of biogases are methane and carbon dioxide together with minor constituents comprising nitrogen, sulfur compounds, oxygen, hydrogen and ammonia.

In order to utilize the methane contained in the biogas it is therefore necessary to process the biogas in a multistage process in order to remove the unwanted components.

The usual process steps per se, which are as a rule carried out separately, comprise dehumidification (removal of water), desulfurization and the removal of carbon dioxide and ammonia.

Biological adsorption methods (using microorganisms) as well as chemical adsorption methods of desulfurization are known in which the hydrogen sulfide is converted to elemental sulfur in different ways.

Carbon dioxide as well as small amounts of hydrogen sulfide are removed by physical or chemical means, for example by pressure water scrubbing, membrane processes, the Selexol process (under high pressure), pressure swing adsorption or amine scrubbing.

Some of these methods also remove water or ammonia.

Most of the above-named methods are energy-intensive and result in methane losses.

Relatively high losses of methane occur with the pressure water scrubbing and pressure swing adsorption methods amounting to approximately 2 to 5% of the methane contained in the biogas. Furthermore, this methane, which is contained in the carbon dioxide that has been removed, can be used as a fuel only by means of an auxiliary firing system because it is present in such small concentrations. In addition, owing to the way the pressure swing adsorption system operates, sharp fluctuations in methane emissions occur that requiring smoothing out. Moreover, the raw gas must contain only a very small concentration of H₂S, necessitating a time-consuming and costly disposal of the activated charcoal used.

Scrubbing with a scrubbing solution such as an amine scrubbing is economically justifiable only if the contaminated scrubbing solution is regenerated.

A process is known from DE 10 200 051 952 B3 for producing methane and liquid carbon dioxide from refinery gas and/or biogas. The raw gas is purified in a preliminary stage (removal of impurities such as NH₃, H₂SO₄, H₂S, SO₂ and COS) and subsequently fed to an absorption column in which the carbon dioxide contained in the raw gas is bound in the scrubbing solution at a pressure preferably of 5 to 30 bar using an amine-containing scrubbing solution. The purified gas accruing contains approximately 98% methane by volume and can be utilized directly for other purposes. The contaminated scrubbing solution is regeneratively processed in a stripping column under pressure and at increased temperatures (180 to 230° C.).

The method using pressure requires a high level of expenditure on apparatus.

A method of removing methane and carbon dioxide from biogas is known from WO 2008/034473 A1 which makes it possible to remove carbon dioxide without pressure and in which methane gas with a purity of over 99.5% accrues.

As with all amine scrubbing a relatively large amount energy amounting to 0.5 to 0.8 kWh/Nm³ biogas is consumed to regenerate the scrubbing solution.

The aim of the invention is to devise a method of purifying biogas for extracting methane that is characterized by low energy consumption and enables the methane content to be increased by at least 10% with low methane losses. In addition, a system suitable for carrying out the method is to be devised.

The above aim is solved according to the invention by means of the features specified in claim 1. Advantageous embodiments of the method are the subject of claims 2 to 11. The features of a system suitable for carrying out the method are specified in claim 12. Advantageous developments of this system are the subject of claims 12 to 18.

The purification process takes place according to the proposed method in at least three purifying steps which take place in immediate succession to each other, using additive-free fresh water conducted in the circuit. Water taken from the local supply network or well water or prepared rain water can be used as fresh water. The water used contains no additives. The three purifying steps which it is absolutely vital to carry out are as follows:

The biogas (raw gas) to be purified which is led off from a biogas plant or other plant, e.g. a plant for producing digester gas, sewage gas or landfill gas flows through a scrubbing column with a packed bed under standard pressure or at an overpressure of up to 6 bar in counterflow to the fresh water fed in. In this process carbon dioxide, hydrogen sulfide, ammonia and other organic water-soluble substances contained in the raw gas are bound in the fresh water. Methane gas with a methane content of at least 65% is drawn off at the head of the scrubbing column.

This gas scrubbing is carried out as a rule under standard pressure. In exceptional cases, however, the system can also be operated with overpressure up to 3 or 4 bar subject to a maximum of 6 bar. With a higher pressure a greater amount of carbon dioxide, which can be as much as three times as great at 3 bar, is dissolved in the scrubbing solution. The amount of scrubbing solution required is therefore smaller by a factor of three and the scrubbing column can be of smaller dimensions because of the smaller gas volume. All conventional compressed gas scrubbing methods require a pressure of over 6 bar in order to produce methane concentrations of over 96% by volume economically. However, a higher pressure leads to a significantly higher energy consumption because the system must be subsequently decompressed again. Moreover, there are higher methane losses.

The two purifying steps set out below carried out by stripping columns are vital to ensure that the method is successfully carried out. The contaminated scrubbing solution discharged from the scrubbing stage is purified in a first stripping column with packed bed or packing by adding 0.1 to 10% stripping air or stripping air and oxygen based on the amount of biogas (raw gas) and fed in under standard pressure in the counterflow principle at temperatures of up to 60° C., with the methane almost completely removed (at least 90%) from the scrubbing solution in which it was dissolved. An oxygenic stripping gas of fuel gas quality is formed in this process as an exhaust gas which can either be returned to the digester of the biogas plant or fed to the methane gas stream removed from the scrubbing stage to enrich the methane content or utilized as a fuel gas.

The first stripping column can also preferably be constructed as a two-stage column with oxygen fed in the first stage and stripping air fed in the second stage, or vice versa. This enables two different fuel gases with different oxygen contents to be produced. The fuel gas with a high oxygen content can, for example, be used as a source of oxygen for a biological desulfurization of the biogas either in the digester or externally.

The contaminated scrubbing solution discharged from the first stripping column is purified under standard pressure in the counterflow principle in a second stripping column with packed bed or packing by adding at least 25% of stripping air based on the amount of biogas (raw gas) fed in, with the carbon dioxide dissolved in the scrubbing solution removed to a residual content of at least under 200 mg/l. The purified scrubbing solution is returned to the scrubbing stage of the gas scrubber and the exhaust gas is released to the surroundings or utilized for other purposes.

The proposed method results in comparatively small methane losses of under 0.05%. When the system is operated under standard pressure, the energy consumption for the three purifying steps is less than 0.03 kWh/Nm³ biogas, enabling the system to be operated extremely economically. In addition, the exhaust gas which accrues in the first stripping stage and is of fuel gas quality can be used for energy production. This is particularly important if biogas is to be used for feeding into a natural gas network or producing fuel. In such cases no waste heat from electricity generation is available. The waste heat from a biomethane compression is not sufficient for heating the digester. In that case additional fossil fuel must be provided. The fuel gas produced as a by-product can be put to good use to heat the digester.

Alternatively, the purified biogas drawn off from the scrubbing column for increasing the methane concentration and storage capacity of the biogas in the digester can be conducted directly into the digester of the biogas plant.

By linking the method according to the invention with a biogas plant in this way a biogas with a significantly higher methane content can be produced in the digester and the storage capacity of the biogas greatly extended. The biogas drawn off from the digester with an increased methane concentration is then available for immediate commercial exploitation without further processing.

The purified biogas (methane gas) drawn off from the scrubbing stage is already sufficiently pure for immediate further use, e.g. for feeding into natural gas networks or for operating combined heat and power plants. If natural gas of greater purity is required, the methane gas present can be adjusted to the required degree of purity by further processing or purification by means of an amine scrubbing. The methane gas can be fed—either on its own or with the stripping gas (fuel gas) discharged from the first stripping column—to a further processing stage to increase the methane content. A subsequent amine scrubbing as well as the regeneration of the scrubbing solution can be carried out with significantly less expenditure of energy and significantly fewer methane losses because the major part of the impurities have already been removed from the biogas.

The fresh water is then fed to the first purifying stage, the scrubbing column, at a temperature of up to 65° C., preferably under 20° C. Ground water at a temperature of 10 to 15° C. can be used as fresh water.

The lower the temperature of the scrubbing solution the higher the separating capacity for carbon dioxide. With warm ambient temperatures, the scrubbing solution should therefore be cooled before being conducted into the gas scrubber. The separating capacity for the carbon dioxide dissolved in the scrubbing solution can be set via the parameters of amount of scrubbing solution/h and scrubbing solution temperature in the scrubbing column. A greater quantity of scrubbing solution and a lower scrubbing solution temperature lead to a higher separating capacity.

It should be noted as regards the amounts of stripping air to be fed to the two stripping columns that only a small amount of stripping air is fed to the first stripping column to separate the methane from the scrubbing solution, with a markedly higher amount being fed to the second stripping column to remove the CO₂.

The proportions depend on the dimensioning of the stripping columns and the methane content in the biogas (raw gas).

The ratio of the amount of stripping air amount of biogas (raw gas) in the first stripping stage should therefore amount to 1:50 to 1:1000, preferably 1:100. A higher methane concentration is achieved in the stripping gas (exhaust gas) with a small ratio of 1:50 than with larger ratios. At the same time, it should be borne in mind that methane slip may occur. The ratio of the amount of stripping air amount of biogas (raw gas) in the second stripping stage should be 1:0.3 to 1:10, preferably 1:2.

The higher the ratio the greater is the residual content of dissolved CO₂ in the purified scrubbing solution. The ratio of the amounts of stripping air in the first stripping stage: second stripping stage should be 1:200 to 1:3000. Normal air should preferably be used as stripping air, though both oxygen and nitrogen are suitable, either separately or as a mixture.

The biogas fed in should be set to a sulfur content of <5 ppm before being conducted into the scrubbing stage or gas scrubber. This can be done by a desulfurization unit known per se in the digester or by means of a separate predesulfurization unit. If the sulfur content is too high, e.g. over 30 ppm in the contaminated scrubbing solution of the scrubbing stage, it may be necessary to replace the scrubbing solution conducted in the circuit partly or completely by fresh water. In order to avoid this, part of the scrubbing solution drawn off from the base of the second stripping column can be removed from the circuit and a reactant that binds hydrogen sulfide, e.g. iron-III-chloride or iron-III-oxide added to said scrubbing solution whereby the dissolved hydrogen sulfide is chemically bound and the scrubbing solution is returned to the circuit after the precipitation of the iron-II-disulfide. With concentrations of hydrogen sulfide in the biogas exceeding 30 ppm the gas scrubbing can at the same time be used for external desulfurization in which case a suitable desulfurization unit, e.g. via biofilters is to be positioned downstream of the stripping gas from the second stripping stage.

The proposed system for carrying out the method is of simple and inexpensive construction and is explained in greater detail below.

The drawings show the following details:

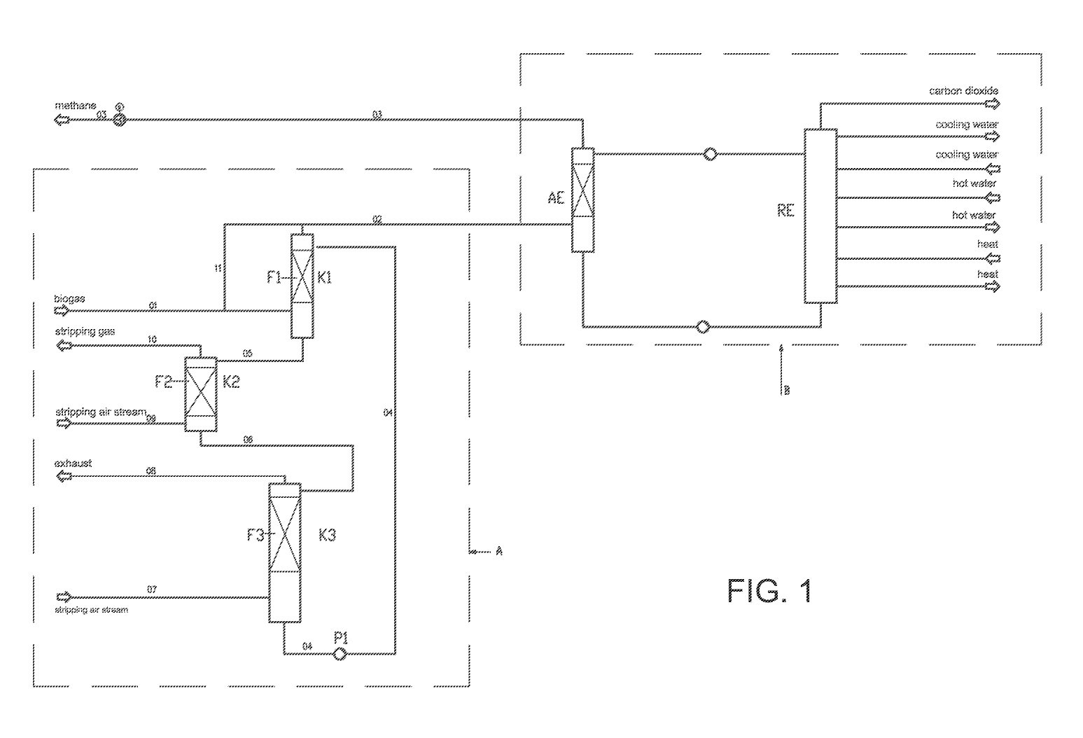

FIG. 1 an initial embodiment variant of a system for carrying out the method in simplified representation

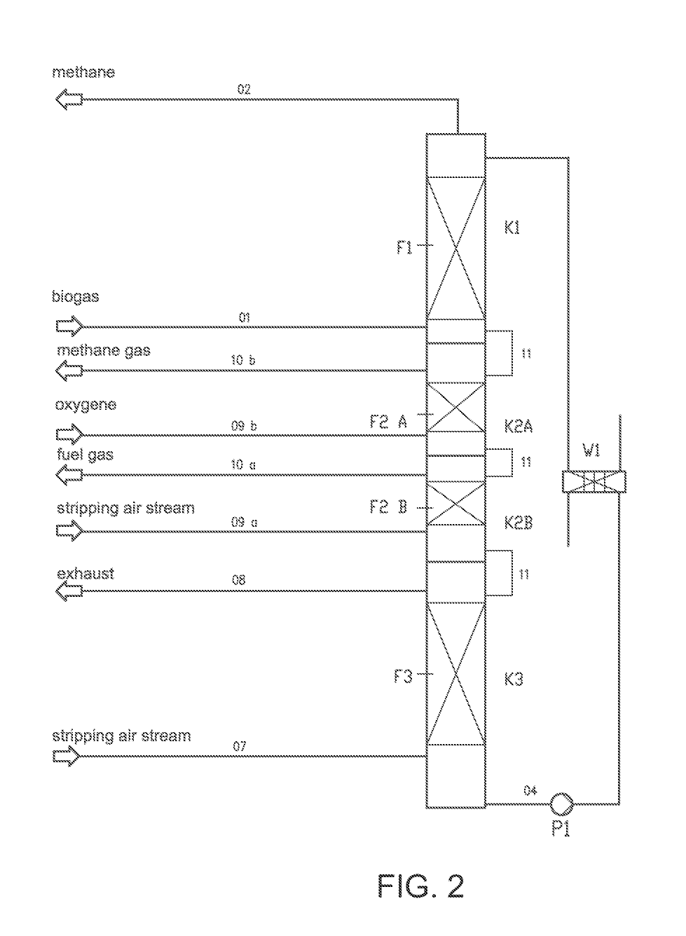

FIG. 2 a second embodiment variant of the purifying unit A in simplified representation

The system shown in FIG. 1 comprises a purifying unit A according to the invention for extracting methane from biogas and an optionally connectable assembly B for a subsequent amine scrubbing in a manner known per se. The main components of the assembly B for the amine scrubbing comprise an absorption unit AE for the further removal of carbon dioxide from the biogas prepurified in the purifying unit A and a regeneration unit RE for the regeneration of the contaminated scrubbing solution accruing containing amines conducted in the circuit.

The purifying unit A comprises three scrubbing columns connected in series, a scrubbing column (gas scrubber) K1, a first stripping column K2 and a second stripping column K3 with the components contained in the biogas (raw gas), such as carbon dioxide, sulfur compounds, ammonia and other water-soluble substances removed in the scrubbing column K1. The scrubbing column K1 comprises a scrubbing tower with a packed bed or packing F1 made of polyethylene particles with a surface area of 200 to 850 m²/m³ and a bed height of 2 to 16 m dependent on the required degree of CO₂ removal.

The first stripping column K2 and the second stripping column K3 each comprise a tower with a packed bed F2 or F3 made of polyethylene particles. The first stripping column K2 contains polyethylene particles with a surface area of 250 to 900 m²/m³, preferably 300 to 790 m²/m³ and a bed height of 2 to 4 m. In the second stripping column K3 the bed height is 2 to 8 m with polyethylene particles with a surface area of 100 to 480 m²/m³ used as packing. The scrubbing columns K1, K2 and K3 are interconnected via a circulation line 04, 05, 06, with a pump P1 integrated into the line 04. The pump P1 circulates the scrubbing solution fed in drawn from a well or the local supply network or rainwater harvesting.

The biogas to be purified is conducted into the scrubbing column K1 via the line 01 below the packed bed F1. The scrubbing solution is fed in at the head of the scrubbing column K1 via the line 04 and flows through the packed bed or packing F1 in counterflow to the biogas fed in. Purified biogas (methane gas) is drawn off at the head of the scrubbing column K1 via the line 02. Contaminated scrubbing solution is drawn off at the base of the scrubbing column K1 via the line 05 and conducted into the first stripping column K2 at its head. A first stripping air stream enters the stripping column K2 below the packed bed F2 of said stripping column via the line 09. The stripping gas formed (exhaust gas) is drawn off at the head of the stripping column K2 via the line 10. Contaminated scrubbing solution accruing at the base of the stripping column K2 is drawn off via the line 06 and conducted into the second stripping column K3 at its head. A second stripping air stream is fed in below the packed bed F3 of the second stripping column K3 via the line 07. The accruing stripping gas (exhaust gas) is drawn off at the head of the stripping column K3 via the line 08. The purified scrubbing solution accruing at the base of this stripping column K3 is pumped via the line 04 to the head of the first scrubbing column K1. The contact between stripping gas and scrubbing solution in the scrubbing columns K2 and K3 is effected by counterflow. Stripping gas containing methane can be fed to the line 02 via a shunt line 11 integrated into the line 01. The stripping processes are carried out under standard pressure.

If the operator requires further methane enrichment of the methane gas drawn off via the line 02, this gas can be fed to the downstream amine scrubbing (component B). The high-purity methane gas is drawn off at the head of the absorption unit AE via the line 03 after the amine scrubbing. The purifying unit A can also be operated without a subsequent amine scrubbing. The only difference between the purifying unit A shown in FIG. 2 and the scrubbing unit A shown in FIG. 1 is that the individual purifying steps K1 to K3 in the former unit are arranged in a single-stage tower and the stripping column K2 is constructed in two parts divided into the upper column section K2A and the lower column section K2B, each of which have a packed bed F2A or F2B.

Oxygen is fed to the column section K2A via the line 09b and air is fed to the column section K2B as a stripping medium via the line 09a.

If for example, only 0.5 Nm³/h oxygen is fed to the column section K2A, 4 Nm³/h of dissolved methane is removed from the scrubbing solution. A methane gas with high oxygen content that is used as a source of oxygen for a biological desulfurization of the biogas (raw gas) is drawn off via the line 10b.

The residual methane still contained in the contaminated scrubbing solution is removed by means of air from said scrubbing solution in the downstream column section K2B. The fuel gas led off via the line 10a is fed to a thermal utilization system.

The accruing contaminated scrubbing solution is conducted through each of four overflows 11 from the scrubbing column K1 into the first stripping column K2 and from this into the second stripping column K3.

The separating plates arranged between the individual columns are constructed so as to be technically leakproof as regards gas loading and completely permeable as regards fluid loading. In addition, a heat exchanger W1 for cooling the scrubbing solution is integrated into the circulation line 04 downstream of the pump P1.

The mode of operation of the systems is explained by means of the examples set out below.

### EXAMPLE 1

The biogas which originated from the digester of a biogas plant and has already been desulfurized in the digester without adding air or oxygen has the following composition:

| | | |
|---|---|---|
| Methane | 52% | by volume |
| Carbon dioxide | 44% | by volume |
| Water | 3.4% | by volume |
| Hydrogen | 0.1% | by volume |
| Oxygen | 0.1% | by volume |
| Nitrogen | 0.4% | by volume |
| H₂S | 3 | ppm |
| NH₃ | 20 | ppm |

Biogas (500 Nm³/h) at a temperature of 38 to 45° C. is fed directly from the digester of the scrubbing column K1 and flows through the packed bed (height 6 m), coming into contact in the process with the scrubbing solution which is drawn from the local supply network, conducted in the circuit and fed in a counterflow direction. The scrubbing process takes place under standard pressure (−10 to +20 mbar) with 400 m³/h water fed in, based on the amount of biogas supplied. After a short period of operation the scrubbing solution contains a residual loading of CO₂ of approximately 50 mg/l.

During the pressureless gas scrubbing CO₂, H₂S and NH₃ are removed from the biogas and are dissolved in the scrubbing solution, with the removed proportion of CO₂ amounting to approximately 80%.

333 Nm³/h of purified biogas (methane gas) with the following composition is drawn off at the head of the scrubbing column K1:

| | | |
|---|---|---|
| Methane | 76.8% | by volume |
| Carbon dioxide | 13.2% | by volume |
| Water | 9.15% | by volume |
| Hydrogen | 0.1% | by volume |
| Oxygen | 0.15% | by volume |
| Nitrogen | 0.6% | by volume |
| H₂S | <1 | ppm |
| NH₃ | <1 | ppm |

The contaminated scrubbing solution accruing at the base of the scrubbing column K1 containing entrained methane dissolved in the scrubbing solution (so-called methane slip) is conducted directly in a subsequent second purifying step through a first stripping column K2 in which methane in the counterflow is partially removed from the contaminated scrubbing solution by adding stripping air.

The small amount of stripping air fed in (5 Nm³/h) ensures that, because of the construction of the first stripping column (surface area of packed bed 790 m²/m³; bed height 2 m), more than 98% of approximately 6.8 Nm³/h of the methane dissolved in the contaminated scrubbing solution is removed from said solution by the stripping air. The stripping gas (exhaust gas) drawn off at the head of the first stripping column K2 still contains CO₂ (approximately 4 Nm³/h). The stripping gas (exhaust gas) accruing has a methane content of 43% by volume and has the same quality as a fully-fledged fuel with a calorific value of 74.5 kW.

This can be used for enriching the methane gas stream drawn off from the scrubbing column K1 or used as a fuel or heating gas as a source of energy. The second purifying step therefore ensures that the overall losses of the methane contained in the biogas are kept to a relatively low level and do not exceed a value of 0.5%. The contaminated methane-free scrubbing solution accruing in the first stripping stage K2 is fed directly to a further purifying step, the second stripping stage K3, in which CO₂ is removed from the scrubbing solution by stripping air fed in a counterflow direction. A much larger amount of stripping air is used in the second stripping stage K3 than in the first stripping stage K2.

300 Nm³/h of warm stripping air (25° C.) which absorbs the carbon dioxide bound in the scrubbing solution is fed to the stripping column K3 (surface area of packed bed 480 m²/m³; bed height 4 m). Under these conditions the carbon dioxide loading in the scrubbing solution is reduced from 915 g/l to 50 mg/l. The purified scrubbing solution accruing at the base of the stripping column K3 is fed to the scrubbing column K1 by the pump P1 via the line 04.

The exhaust gas exiting the stripping column K3 can be discharged into the surroundings directly and without any further treatment.

Only 12.5 kW of electrical energy is required for the entire process control of the purifying steps K1, K2 and K3 which is of great importance in terms of the economical operation of the method. This low energy consumption means a specific consumption of 0.025 kWh/Nm³ based on the input of biogas (500 Nm³/h).

The purified biogas (methane content 76.8% by volume) drawn off at the head of the scrubbing column K1 is available for immediate further commercial exploitation or can, if required, be further purified to increase its methane content.

Further purification can, for example, be carried out by an amine scrubbing that is per se known, as described for example in the published documents DE 10 200 051 952 B3 and WO 2008/034473 A1. After the methane gas drawn off at the head of the scrubbing column K1 has been purified by means of an amine scrubbing with a scrubbing agent containing amines, a purified biogas (methane gas) with the following composition is produced:

| | | |
|---|---|---|
| Methane | 88.3% | by volume |
| Carbon dioxide | 0.3% | by volume |
| Water | 10.3% | by volume |
| Hydrogen | 0.17% | by volume |
| Oxygen | 0.17% | by volume |
| Nitrogen | 0.69% | by volume |
| H₂S | 2 | ppm |
| NH₃ | 1 | ppm |

The water still contained in the biogas is removed in a downstream dehumidification stage and the purified biogas set to a dew point temperature of 2° C. after which the biogas has the following composition:

| | | |
|---|---|---|
| Methane | 97.7% | by volume |
| Carbon dioxide | 0.38% | by volume |
| Water | 0.78% | by volume |
| Hydrogen | 0.19% | by volume |
| Oxygen | 0.19% | by volume |
| Nitrogen | 0.76% | by volume |
| H₂S | 2 | ppm |
| NH₃ | 1 | ppm |

The methane content can be increased still further by further cooling and removal of the residual water content and/or reduction of the nitrogen content. However, this will not be necessary for most technical areas of applications of the purified biogas (methane gas). An amine scrubbing (with scrubbing solution regeneration) can be carried out with considerably less energy expenditure than is otherwise necessary for purifying biogas as a raw gas. This is because only small amounts of impurities still remain to be removed in a subsequent amine scrubbing, as the biogas has already been prepurified in the purifying steps K1 to K3.

The thermal energy required for purifying the scrubbing solution containing amines is therefore reduced from 250 kW to 72 kW. The specific heat requirement based on the amount of biogas can therefore be reduced from 0.5 to 0.144 kWh/Nm³. A further advantage is the low methane loss (0.03%) compared with conventional amine scrubbing (0.1%). Of the 72 kW used for the amine scrubbing approximately 85% of thermal energy can be made available again by waste heat recovery for further utilization. This can be used to heat the digester to a temperature of 58° C.

### EXAMPLE 2

Sewage gas with the following composition obtained from the digestion tower of a sewage plant is treated in a similar way to Example 1:

| | | |
|---|---|---|
| Methane | 65.4% | by volume |
| Carbon dioxide | 29.6% | by volume |
| Water | 4.5% | by volume |
| Hydrogen | 0.1% | by volume |
| Oxygen | 0.1% | by volume |
| Nitrogen | 0.3% | by volume |
| H₂S | 2 | ppm |
| NH₃ | 5 | ppm |

Input amount: 500 Nm³/h, temperature from 38 to 45° C.;

### Gas Scrubbing—Scrubbing Column K1

Surface area of the packed bed: 740 m²/m³
Standard pressure; amount of scrubbing solution: 350 m³/h
Composition of the purified biogas (methane gas) drawn off at the head of the scrubbing column K1 at an amount of 333 Nm³/h:

| | | |
|---|---|---|
| Methane | 83.8% | by volume |
| Carbon dioxide | 8.8% | by volume |
| Water | 6.6% | by volume |
| Hydrogen | 0.15% | by volume |
| Oxygen | 0.15% | by volume |
| Nitrogen | 0.4% | by volume |
| H₂S | <1 | ppm |
| NH₃ | <1 | ppm |

### Stripping Column K2:

Surface area of the packed bed: 840 m²/m³
Amount of stripping air fed in: 6 Nm³/h;
4.9 Nm³/h of dissolved methane (=99.7%) is removed from the contaminated scrubbing solution
Stripping gas (exhaust gas) drawn off contains 4 Nm³/h CO₂ and water vapor according to saturation;
Methane content of the stripping gas (fuel gas): 32.2% by volume;
Calorific value of the stripping gas (fuel gas): 54 kW

### Stripping Column K3:

Surface area of the packed bed: 220 m²/m³
Amount of stripping air fed in: 570 Nm³/h;
CO₂ loading reduced from 845 g/l to 50 mg/l

The ratio of the packed bed heights of the columns: K1:K2:K3 is 3:1:2

### Energy Consumption K1 to K3

Electrical energy: 10.5 kW
Specific energy consumption: 0.021 kWh/Nm³
Methane losses amount to only 0.3%

1-18. (canceled)

19. A method of purifying a biogas for extracting methane wherein components contained in the biogas including carbon dioxide, sulfur compounds, ammonia and other water-soluble substances are removed in a multi-stage purification process, which comprises the steps of:
carrying out the multi-stage purification process by performing at least three purifying steps taking place in immediate succession to each other and using additive-free fresh water conducted in a circuit by performing the substeps of:
performing a first purifying step where the biogas to be purified is drawn off from a biogas plant and flows through a scrubbing column with a packed bed having a pressure selected from the group consisting of a standard pressure and at an overpressure of up to 6 bar in counterflow to a fresh water fed in and the carbon dioxide, hydrogen sulfide, the ammonia and the other organic water-soluble substances contained in the biogas are bound in the additive-free fresh water, and a methane gas with a methane content of at least 65% is drawn off at a head of the scrubbing column:
removing most of the methane dissolved in a contaminated scrubbing solution discharged from the scrubbing stage in a first stripping column having a packed bed or packing by adding 0.5 to 10% stripping air or the stripping air and oxygen based on an amount of the biogas and fed in under standard pressure in a counterflow direction at temperatures of up to 60° C., with an oxygenic stripping gas of fuel gas quality produced in the process; and
removing the carbon dioxide dissolved in the contaminated scrubbing solution discharged from the first stripping column to a residual content of under 200 mg/l in a second stripping column having a packed body or packing by adding at least 25% stripping air based on the amount of the biogas and fed in under standard pressure in a counterflow direction, with a purified scrubbing solution fed to the scrubbing stage and an exhaust gas led off.

20. The method according to claim 19, which further comprises setting a temperature of the fresh water conducted in the circuit to up to 65° C.

21. The method according to claim 19, wherein the exhaust gas, functioning as a stripping gas, drawn off the first stripping column is returned to a digester of the biogas plant, is fed to a methane gas stream removed in the first scrubbing stage, or is used as a fuel gas.

22. The method according to claim 19, which further comprises constructing the first stripping column for removing the methane from the contaminated scrubbing solution in two stages with oxygen fed in a first stage and a stripping air fed in a second stage or vice versa and two different fuel gases with different oxygen contents are produced.

23. The method according to claim 22, which further comprises using a fuel gas with a high oxygen content as a source of oxygen for a biological desulfurization of the biogas.

24. The method according to claim 19, which further comprises feeding the methane gas drawn off from the stripping column to a further processing stage to increase the methane content either separately or together with the stripping gas drawn off from the first stripping column.

25. The method according to claim 19, wherein the biogas fed in is set to have a sulfur content of <5 ppm before it is conducted into the scrubbing stage.

26. The method according to claim 19, wherein a scrubbing solution circulating in the circuit is partly or completely replaced by the fresh water after a specified period of operation if a sulfur content in the contaminated scrubbing solution drawn off from the scrubbing stage exceeds 50 ppm.

27. The method according to claim 19, which further comprises the steps of:
removing a partial amount of scrubbing solution drawn off at a base of the second stripping column from the circuit; and
adding a reactant binding hydrogen sulfide to the scrubbing solution and the scrubbing solution is returned to the circuit after precipitation of iron-II-disulfide.

28. The method according to claim 19 wherein a separating capacity for the carbon dioxide dissolved in the scrubbing solution is adjustable by means of parameters of amounts of scrubbing solution/h and scrubbing solution temperature in the scrubbing column, with a higher amount of the scrubbing solution and a lower scrubbing solution temperature leading to a higher separating capacity.

29. The method according to claim 19, wherein the purified biogas drawn off from the scrubbing column for increasing methane concentration and a storage capacity of the biogas in a digester is conducted directly into the digester of the biogas plant.

30. A system for extracting methane gas from a biogas, the system comprising:
a scrubbing column formed as a gas scrubber for removing components contained in the biogas including carbon dioxide, sulfur compounds, ammonia and other water-soluble substances by means of a scrubbing solution;
a first stripping column for removing the methane gas dissolved in a contaminated scrubbing solution;
a second stripping column for removing the carbon dioxide from the contaminated scrubbing solution accruing at a base of the first stripping column, said scrubbing column and said first and second two stripping columns are connected in series;
said scrubbing column having a packed bed or a packing with a surface area of 300 to 900 mm²/m³ and a bed height of 2 to 16 m, said scrubbing column further having a head;
said first stripping column having a packed bed or packing with a surface area of 350 to 900 mm²/m³ and a bed height of 1 to 4 m;
a circulation line having a pump integrated therein; and
said second stripping column having a packed bed or packing with a surface area of 100 to 300 mm²/m³ and a bed height of 1 to 10 m, said second stripping column having a based connected to said head of said scrubbing column by said circulation line carrying the scrubbing solution.

31. The system according to claim 30, further comprising a heat exchanger integrated into said circulation line to cool the scrubbing solution.

32. The system according to claim 30, wherein said scrubbing column and said first and second stripping columns have a same column diameter and different packed bed heights with a ratio of said bed heights of said scrubbing column, said first stripping column, and said second stripping column amounting to 3:1:2 to 3:0, 5.1, respectively.

33. The system according to claim 30, wherein a ratio of said surface areas of said packed beds of said first stripping column and said second stripping column is 1:0.2 to 1:0.8.

34. The system according to claim 30,
further comprising a further line supplying oxygen;
further comprising an additional line supplying air; and
wherein said first stripping column is divided into an upper column section and a lower column section with each of said upper and lower column sections fitted with said packed bed or said packing, said upper column section is connected to said further line supplying the oxygen and said lower column section is connected to said additional line supplying the air.

35. The system according to claim 30, further comprising a tower, said scrubbing column and said first and second stripping columns are disposed in said tower.

36. The system according to claim 30, wherein said scrubbing column and said first and second stripping columns have separating plates constructed so as to be technically leakproof as regards gas loading and completely permeable as regards fluid loading.

37. The system according to claim 30, wherein a ratio of said surface areas of said packed beds of said first stripping column and said second stripping column is 1:0.5.
